(19) United States
(12) Patent Application Publication
(10) Pub. No.: US 2012/0050705 A1
(43) Pub. Date: Mar. 1, 2012

(54) PHOTOLITHOGRAPHY SYSTEM

(75) Inventors: Hiroyuki WASHIYAMA, Tokyo (JP); Takashi OKUYAMA, Saitama (JP)

(73) Assignee: ORC MANUFACTURING CO., LTD., Tokyo (JP)

(21) Appl. No.: 13/220,033

(22) Filed: Aug. 29, 2011

(30) Foreign Application Priority Data
Aug. 30, 2010 (JP) 2010-192072

(51) Int. Cl. G03B 27/42

(52) U.S. Cl. 355/53; 355/77

(57) ABSTRACT

A photolithography system is equipped with a light modulator that comprises a plurality of regularly arrayed light modulation elements; a scanning mechanism configured to move an exposure area relative to an object in a main scanning direction, in a state in which the exposure area is inclined in the main scanning direction; an exposure controller that controls the plurality of light-modulating elements in accordance with a given exposure pitch to carry out an overlapping exposure process in both the main scanning direction and a sub-scanning direction; and an exposure pitch adjuster that calculates an exposure pitch that allows exposure points to be distributed evenly on the basis of an effective area of the light modulator.

### BACKGROUND OF THE INVENTION

1. Field of the Invention

The present invention relates to a mask- or reticle-free photolithography system that directly draws or forms a pattern on a target object such as a substrate. In particular, it relates to a multiple exposure process.

2. Description of the Related Art

In a mask- or reticle-free photolithography system, a light modulator (e.g., a DMD (Digital Micro-mirror Device)), which is equipped with a plurality of two-dimensionally arrayed cells, is controlled to carry out an exposure motion for patterning. In the case of the DMD, light from a light source is reflected off the mirror array, and each mirror is switched between an on and off state on the basis of pattern data. Thus, light corresponding to a pattern is illuminated on a substrate.

When forming a fine and complex two-dimensional pattern, a multiple exposure process is carried out. For example, JP2003-57836A discloses a multiple exposure process. In the multiple exposure process, an exposure pitch or exposure interval is out of an integral multiple of the size of one-mirror worth's of exposure area (unit exposure area), so that the position of a projected area (shot-spot) gradually shifts in a main-scanning direction at a fine interval shorter than the size of the unit exposure area. Thus, the exposure area in each mirror overlaps with one another in the main scanning direction.

At the same time, the main-scanning direction is finely inclined relative to the mirror-array direction of the DMD or the longitudinal direction of the substrate. Thus, a shot-spot shifts in a sub-scanning at fine intervals, and a unit exposure area in each mirror overlaps with one another in the sub-scanning direction. This multiple exposure process, i.e., an overlapping exposure along two directions, makes an amount of illumination light uniform or even with respect to the whole of an exposure area. An exposure pitch and an inclination angle are determined in accordance with an overlap interval, total number of an exposure, etc.

The exposure pitch is determined under the assumption that all of the mirrors are used to form a pattern. However, occasionally only a part of the mirrors are used when carrying out an exposure motion. In this case, if the exposure pitch that has been predetermined in accordance with the whole of mirrors is directly utilized, a series of shot-spots are unevenly distributed on the target exposure area. Consequently, an amount of illumination light cannot be uniform in the exposure area.

### SUMMARY OF THE INVENTION

The present invention is directed to provided a photolithography system with a light modulator that has a plurality of regularly arrayed light modulation elements; a scanning mechanism configured to move an exposure area relative to an object in a main-scanning direction in a state where the exposure area is inclined in the main-scanning direction; and an exposure controller that controls the plurality of light-modulating elements in accordance with a given exposure pitch. Thus, an overlapping exposure process in the main scanning direction and a sub-scanning direction is carried out. The positions of the exposure-shot areas generated by the light modulation elements, i.e., the positions of the exposure points, are distributed two dimensionally. The system according to the present invention is equipped with an exposure pitch adjuster that calculates an exposure pitch that allows exposure points to be distributed evenly, on the basis of an effective area of the light modulator. Light modulation elements in the effective area are used to form a pattern, and the effective area may be set in accordance with an exposure condition, etc.

An apparatus for adjusting an exposure pitch, according to another aspect of the present invention, is equipped with a setter that sets an effective area of a light modulator with a plurality of regularly arrayed light modulation elements; and an exposure pitch adjuster that calculates an exposure pitch that allows exposure points to be distributed evenly on the basis of an effective area of the light modulator.

A method for adjusting an exposure pitch, according to another aspect of the present invention, includes: a) setting an effective area of a light modulator with a plurality of regularly arrayed light modulation elements; and b) calculating an exposure pitch that distributes exposure points evenly on the basis of the effective area of the light modulator.

A computer readable medium, according to another aspect of the present invention, stores a program for adjusting an exposure pitch. The program includes a setting-code segment that sets an effective area of a light modulator with a plurality of regularly arrayed light modulation elements, and an exposure pitch adjustment-code segment that calculates an exposure pitch that allows exposure points to be distributed evenly, on the basis of an effective area of the light modulator.

### BRIEF DESCRIPTION OF THE DRAWINGS

The present invention will be better understood from the description of the preferred embodiments of the invention set forth below together with the accompanying drawings, in which:

FIG. 1 is a schematic perspective view of a photolithography system according to the present embodiment;

FIG. 2 is a schematic sectional view of the photolithography system;

FIG. 3 is a block diagram of the system controller in the photolithography system;

FIG. 4 is a view showing a slanted exposure area relative to the main-scanning direction;

FIG. 5 is a view showing an exposure-point distribution in a target area with the same size as that of the unit exposure area;

FIG. 6 is a view showing an exposure-point distribution in the case that mirrors are partially used;

FIG. 7 is a view showing an exposure-point distribution in the case that mirrors are partially used;

FIG. 8 is a view showing an exposure-point distribution after an adjustment of an exposure pitch; and

FIG. 9 is a flowchart of the exposure pitch calculation process.

### DESCRIPTION OF THE PREFERRED EMBODIMENTS

Hereinafter, the preferred embodiment of the present invention is described with reference to the attached drawings.

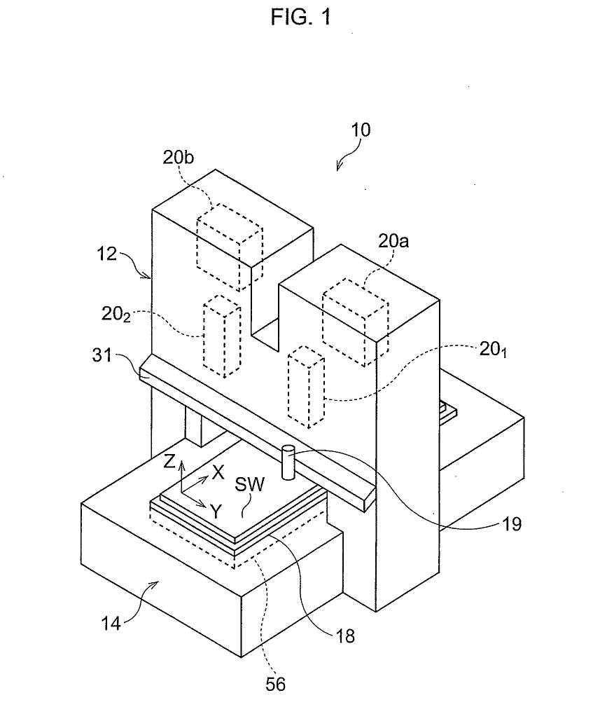

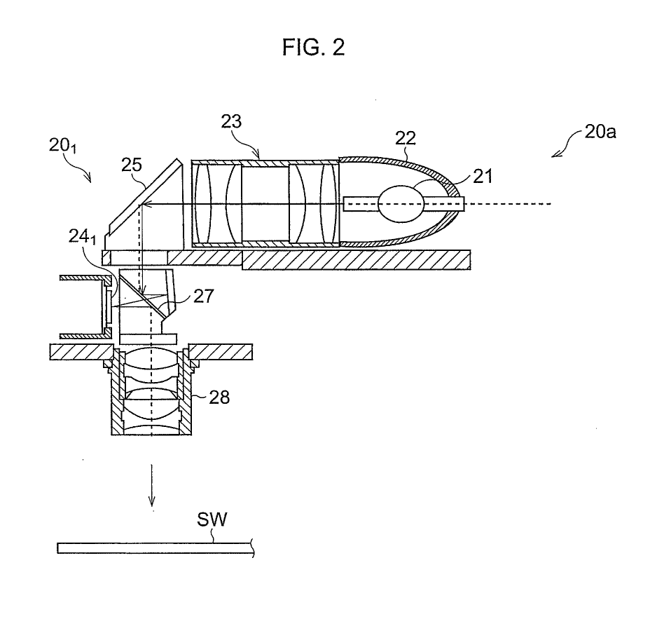

FIG. 1 is a schematic perspective view of a photolithography system according to the present embodiment. FIG. 2 is a schematic sectional view of an exposure unit.

A photolithography system 10 with a gate member 12 and a base 14 is an apparatus for projecting light onto a substrate SW, which has been coated with or attached to a photo-sensitive material, in order to create an image or form a pattern on the substrate SW. For example, a circuit pattern or solder-resistant pattern can be formed. An exposure motion performed by the system 10 is controlled by a system controller (herein, not shown). The system controller is connected to an input device (not shown) such as a monitor, keyboard, etc., and the exposure motion is carried out in accordance to an operation of an operator.

The gate member 12 is equipped with light sources 20a and 20b and exposure heads 20₁ and 20₂, which are apart from each other by a given interval. The light sources 20a and 20b, which are on opposite sides of the gate member 12 from each other, supply illumination light to the exposure heads 20₁ and 20₂. The exposure heads 20₁ and 20₂ project light emitted from the light sources 20a and 20b onto the substrate SW to form a pattern. The exposure head 20₁ has a DMD 24₁ as shown in FIG. 2, and the exposure head 20₂ also has a DMD (not shown). A CCD camera 19 is disposed on a guide member 31 of the gate member 12, and captures alignment marks formed on the substrate SW to detect deformation in the substrate SW.

The base 14 is equipped with a stage mechanism 56 that supports a table 18, and the substrate SW is positioned on the table 18. The substrate SW may be a silicon wafer, film, or glass board. Before the exposure process, photo-resistant coating is applied to the substrate SW and it is put on the table 18 as a blank. Herein, a circuit board is used.

On the table 18, X-Y-Z coordinates perpendicular to each other are defined. The table 18 can move in both of the X and Y directions, and rotate around the Z direction to adjust the moving direction of the substrate SW. Herein, the X direction corresponds to a main scanning direction and the Y direction corresponds to a sub-scanning direction. Note that the main scanning direction is oriented opposite to the direction of movement of the substrate SW, i.e., the main scanning direction is in the −X direction.

As shown in FIG. 2, the light source 20a is equipped with a discharge lamp 21 and a reflector 22. Diffusion light emitted from the discharge lamp 21 is directed to an illumination optical system 23, which changes the diffusion light to parallel light. The parallel light is directed to the DMD 24₁ via a plane mirror 25 and a half mirror 27. The DMD 24₁ is constructed of rectangular micro-mirrors, which are regularly arrayed in a matrix. Herein, the DMD 24₁ is composed of 1024×768 square-shaped micro-mirrors.

In the DMD 24₁, each micro-mirror is switched between on and off states independently in accordance with exposure data such as raster data, and only light reflected off the micro-mirror when it is in the first (on) position is directed to the substrate SW. Therefore, the light irradiating the substrate SW is from a selectively reflected luminous flux, which corresponds to a pattern to be formed on a target area.

When all of the micro-mirrors are positioned in the first position, a projection spot EA is formed on the substrate SW. Hereinafter, the projection area EA is designated as an “exposure area”. Since the power of the objective optical system 26 is herein 1, the size of the exposure area EA coincides with that of the DMD 24. While the substrate SW moves in the main scanning direction, the exposure area EA moves relative to the substrate SW. As for the exposure method, herein, the multi-exposure method and the Step & Repeat method are applied. Accordingly, each mirror is controlled in accordance with an exposure pitch that allows a multiple exposure process. The DMD in the exposure head 20₂ also forms a pattern while the substrate SW relatively moves.

Also, the exposure area EA is slanted to the main-scanning direction by a fine angle. Since the exposure head 20₁ is arranged such that the array-direction of the mirrors in the DMD 24₁ is parallel to the main-scanning direction, the position of the exposure area deviates from the main-scanning direction (X-direction). This deviation allows a higher resolution pattern two-dimensionally.

When the substrate SW moves to the end position, the substrate SW shifts along the sub-scanning direction and moves along the next scanning band. After the exposure process has been completed for the total substrate SW, the substrate SW is removed from the photolithography system 10 and a developing process, an etching/plating process, and/or a resist-removal process are carried out. Thereby, a circuit substrate, on which a pattern is formed, is generated.

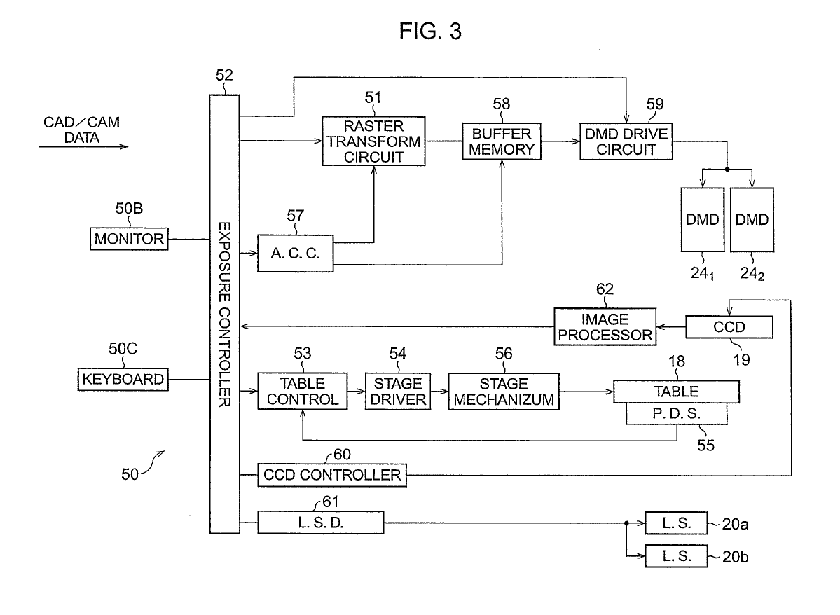

FIG. 3 is a block diagram of the system controller in the photolithography system 10.

The system controller 50 is connected to a workstation (not shown). Based on operation signals from a keyboard 50C, an exposure controller 52 controls the exposure process and outputs control signals to a DMD drive circuit 59, an address control circuit 57, a table control circuit 53, and so on. A program for controlling the exposure process is stored in a ROM unit provided in the exposure controller 52.

The workstation outputs vector data to the exposure controller 52 as pattern data (CAD/CAM data). The vector data transferred from the workstation includes X-Y coordinate information. A raster transform circuit 51 transforms the vector data into raster data. The generated raster data is 2-dimensional dot pattern data represented by 0s and 1s, which correspond to an image of the circuit pattern and determine the on/off position of each micro-mirror.

The Raster data is generated in each exposure head and temporarily stored in a buffer memory 58. The address control circuit 57 reads the stored raster data from the buffer memory 58 and sends the raster data to the DMD drive circuit 59.

Based on the raster data, the DMD drive circuit 59 outputs on/off control signals to the DMD 24₁ and 24₂ while synchronizing the control signals with timing signals fed from the exposure controller 52. While the exposure areas move relatively, the DMD 24₁ and 24₂ are controlled in accordance with raster data corresponding to the positions of the exposure areas.

The table control circuit 53 outputs control signals to a stage driver 54 to control the speed and direction of the movement of the stage mechanism 56. A position sensor 55 detects a position of the table 18 to detect the relative position of the exposure area EA during scanning. Based on the detected relative position of the exposure area EA, the exposure controller 52 controls the DMD drive circuit 59 and the address control circuit 57.

Image-pixel signals generated in the CCD 19 are subjected to an imaging process by the image processor 62, and generated image signals are fed to the exposure controller 52. The exposure controller 52 outputs alignment data to the monitor 50B and detects the position of alignment marks formed on the substrate SW. A CCD controller 60 controls the movement of the CCD 19.

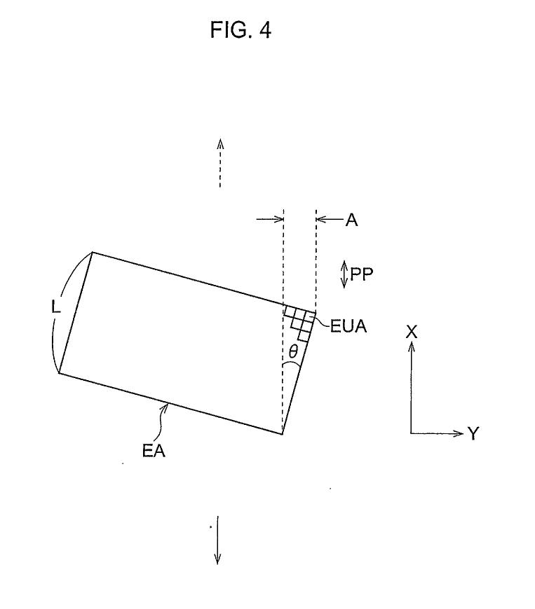

Hereinafter, an exposure distribution and the calculation of an exposure pitch according to an overlapping exposure are explained with reference to FIGS. 4 to 9.

FIG. 4 is a view showing a slant of the exposure area relative to the main-scanning direction.

As described above, the exposure area EA is inclined relative to the main scanning direction (X-direction) by a fine angle θ, since the substrate SW is inclined toward the mirror-array direction of the DMD 24₁ and 24₂. Note that, in FIG. 4, the slant angle θ of the exposure area EA is exaggerated. While the exposure area EA moves relative to the substrate SW, an overlapping exposure process is carried out in accordance with an exposure pitch “PP” that is significantly shorter than the length of the exposure area EA. The direction that the substrate SW moves is shown by a broken-line arrow and the direction that the exposure unit EA moves is shown by a solid-line arrow.

The exposure area is constructed from a plurality of projected areas corresponding to the series of mirrors (hereinafter, called a “unit exposure area”) EUA. The array of the unit exposure areas EUA is inclined in the main-scanning direction, so that a series of unit exposure areas, which is formed by mirrors across a plurality of columns, passes through the same scanning line along the X-direction while the whole of the exposure area EA passes through an illuminated area that is the same size as that of one unit exposure area EUA. Note that a column represents a line of the unit exposure areas (i.e., the mirrors) along the main-scanning direction (X-direction). Consequently, shot areas illuminated by the mirrors (hereinafter, called an “exposure-shot-area”) overlap with one another along the main scanning direction and sub-scanning direction.

The inclined angle θ of the exposure area EA, i.e., the inclined angle θ of the substrate SW, is determined in accordance with the degree of the overlap, i.e., the total overlapping distance along the sub-scanning direction. As well known, the inclined angle θ is calculated by the following equation:

θ=A/L (1)

Note that “L” represents the length of the exposure area EA along the main-scanning direction. Also, “A” represents the number of columns described above. In FIG. 4, the number of columns A is three.

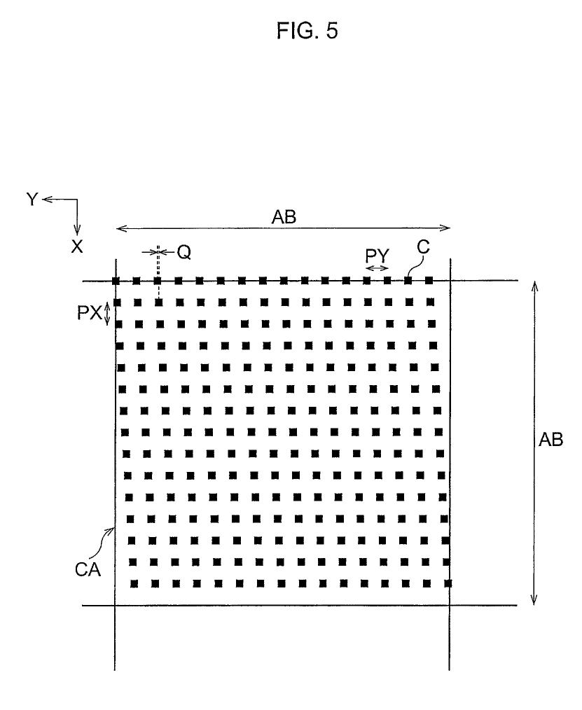

FIG. 5 is a view showing an exposure-point distribution in an area the same size as that of the unit exposure area EUA (hereinafter, called a “target area”). Herein, the uniform exposure-point distribution is explained with reference to FIG. 5.

In FIG. 5, an exposure-point distribution in a target area CA as seen from the substrate SW is shown. An exposure point C represents the center positions of exposure-shot areas when carrying out an overlapping exposure motion based on an exposure pitch PP.

The exposure pitch PP along the main-scanning direction is shorter than or outside of the width of the unit exposure area EUA, such that the exposure points C are aligned at equal intervals in the main scanning direction. Furthermore, the exposure pitch PP is set such that exposure points C are decentralized or totally and evenly dispersed along the main and sub-scanning directions.

In FIG. 5, 16×16 (=256) exposure points C along the main and sub-scanning directions are uniformly or evenly distributed in the target area CA (AB×AB). The interval PX and PY between neighboring exposure points are herein generally equal. Also, an interval Q that represents a deviation along the sub-scanning direction between neighboring exposure points aligned in the main scanning direction is also generally constant. The inclined angle θ and the exposure pitch PP are determined such that a 16×16 exposure point array as shown in FIG. 5 is realized.

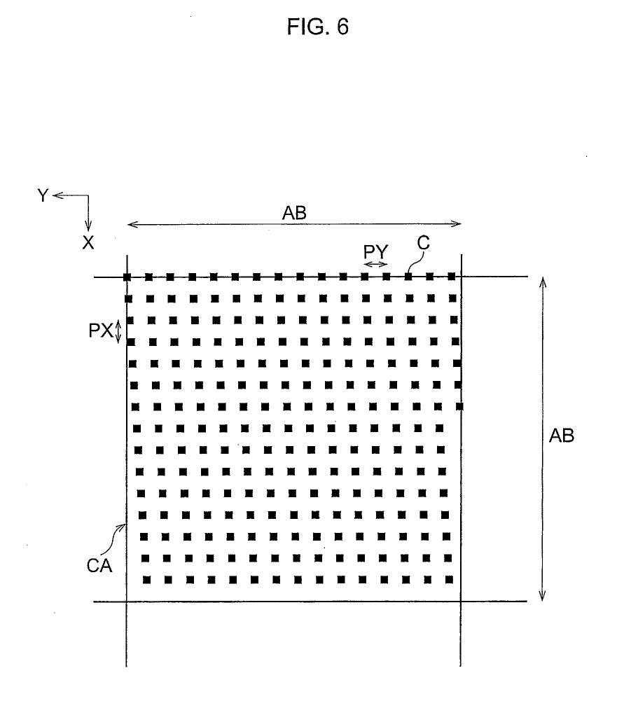

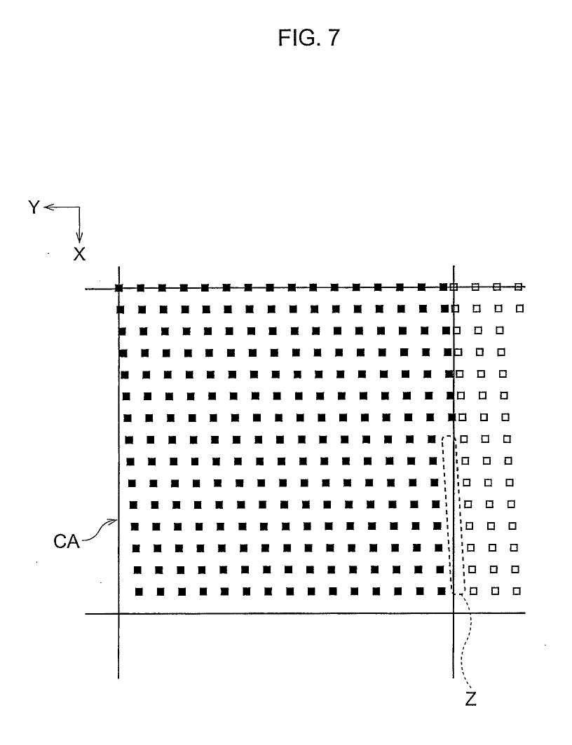

FIGS. 6 and 7 are views showing exposure-point distributions in the case that mirrors are partially used.

The exposure-point distribution shown in FIG. 5 represents the distribution in a condition in which all of the mirrors that can be used to form a pattern are used, and the inclined angle θ and the exposure pitch PP are determined on the basis of an assumption that uses the whole of the effective mirrors. However, occasionally part of the DMD mirror area cannot be utilized. In this case, an exposure-point distribution will not be uniform.

In FIG. 6, an uneven exposure-point distribution in the target area CA is illustrated. When the number of overlaps or the inclined angle θ is modified, some exposure points fall outside the target area CA. To prevent exposure points from existing within a neighboring target area, the area of the effective mirrors is restricted. Concretely, a group of rectangular-arrayed mirrors that exist on the backend side with respect to the main-scanning direction are not utilized.

Consequently, an exposure point does not exist in a partial area Z as shown in FIG. 7, and an exposure-point distribution becomes an uneven distribution. In the present embodiment, a proper exposure pitch that results in a uniform exposure-point distribution is calculated in accordance with an effective area of the micro-mirrors.

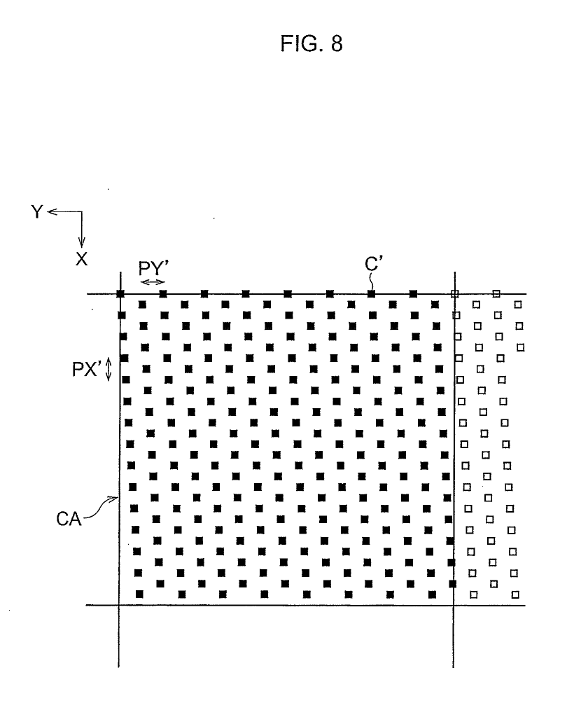

FIG. 8 is a view showing an exposure-point distribution after an exposure pitch has been adjusted.

In FIG. 8, a modified uniform exposure-point distribution is illustrated. The arrangement of exposure points C′ becomes a staggered arrangement, in general. Then, the intervals between the neighboring exposure points PX′ and PY′ are different from PX and PY shown in FIG. 4. Note that PX′ is herein substantially equal to PY′. The exposure points C′ are evenly distributed such that the intervals between neighboring exposure points are generally constant.

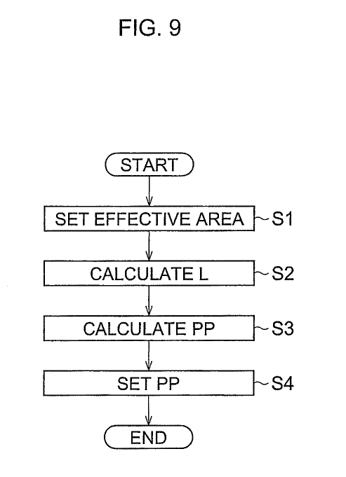

FIG. 9 is a flowchart of the exposure pitch calculation process.

Firstly, based on exposure conditions, an effective area in which mirrors are actually used for patterning is determined (S1). The setting of the effective area is, for example, carried out by an input operation of a user. Accordingly, a length of an effective exposure area along the main scanning direction, which corresponds to an effective area in the DMD, is calculated (S2). The length L is the product of the length L0 of the effective area of the DMD along the main scanning direction and the magnification m of the projection optical system 28 (L=L0×m).

Then, an exposure pitch PP is calculated from the following equation:

PP=L/N=(L0×m)/N (2)

Note that N represents the sum of the number (totalizing number) of exposures that are carried out while the whole of the exposure area EA passes through the target area CA.

As shown in formula (2), the exposure pitch PP representing the distance of an interval in an overlapping exposure motion is obtained by dividing the effective exposure length L by the integral number of exposures. After the exposure pitch PP is set (S4), the overlapping exposure process is carried out.

In this way, the photolithography system according to the present embodiment carries out an overlapping exposure process in a state in which the exposure area EA is inclined in the main scanning direction, and calculates an exposure pitch PP in accordance with the effective area of the DMD. Therefore, even if an exposure area is modified by a change in the exposure condition or exposure mechanism, the exposure points can be uniformly distributed so that a fine pattern is formed without uneven illumination.

The effective area of the DMD may be optionally set. For example, the effective area may be set by excluding mirrors outside of the DMD, or a partial rectangular area of a mirror area may be set as an effective area. Also, the target area may be set in accordance with a change in the magnification of the projection. The exposure point may be evenly distributed in the changed target area.

Finally, it will be understood by those skilled in the arts that the foregoing description is of the preferred embodiments of the device, and that various changes and modifications may be made to the present invention without departing from the spirit and scope thereof.

The present disclosure relates to subject matter contained in Japanese Patent Application No. 2010-192072 (filed on Aug. 30, 2010), which is expressly incorporated herein, by reference, in its entirety.

1. A photolithography system comprising:
a light modulator that comprises a plurality of regularly arrayed light modulation elements;
a scanning mechanism configured to move an exposure area relative to an object, in a main-scanning direction, in a state in which the exposure area is inclined in the main scanning direction;
an exposure controller that controls said plurality of light-modulating elements in accordance with a given exposure pitch to carry out an overlapping exposure process in the main scanning direction and a sub-scanning direction; and
an exposure pitch adjuster that calculates an exposure pitch that allows exposure points to be distributed evenly, on the basis of an effective area of said light modulator.

2. The photolithography system of claim 1, wherein the exposure pitch adjuster divides the length along the main scanning direction of an effective exposure area corresponding to the effective area by a totalizing number of an exposure to obtain the exposure pitch.

3. An apparatus for adjusting an exposure pitch, comprising:
a setter that sets an effective area of a light modulator, said light modulator comprising a plurality of regularly arrayed light modulation elements; and
an exposure pitch adjuster that calculates an exposure pitch that allows exposure points to be distributed evenly, on the basis of an effective area of said light modulator.

4. A method for adjusting an exposure pitch, comprising:
setting an effective area of a light modulator, said light modulator comprising a plurality of regularly arrayed light modulation elements; and
calculating an exposure pitch that allows exposure points to be distributed evenly, on the basis of the effective area of said light modulator.

5. A computer readable medium that stores a program for adjusting an exposure pitch, said program comprising:
a setting code segment that sets an effective area of a light modulator, said light modulator comprising a plurality of regularly arrayed light modulation elements; and
an exposure pitch adjustment code segment that calculates an exposure pitch that allows exposure points to be distributed evenly, on the basis of an effective area of said light modulator.
